(19) United States
(12) Patent Application Publication
(10) Pub. No.: US 2024/0210530 A1
(43) Pub. Date: Jun. 27, 2024

(54) LIDAR APPARATUS

(71) Applicant: NEC Corporation, Tokyo (JP)

(72) Inventor: Takahiro ONO, Tokyo (JP)

(73) Assignee: NEC Corporation, Tokyo (JP)

(21) Appl. No.: 18/543,048

(22) Filed: Dec. 18, 2023

(30) Foreign Application Priority Data
Dec. 23, 2022 (JP) 2022-206482

(51) Int. Cl. G01S 7/481; G01S 17/42

(52) U.S. Cl. CPC G01S 7/4817; G01S 17/42

(57) ABSTRACT

A LiDAR apparatus includes a laser light source, at least one lens that controls an optical path of emission light from the laser light source, and a conical scanning mechanism that controls an optical path of emission light from the laser light source. The conical scanning mechanism includes at least one wedge prism, and a drive source that rotationally drives the at least one wedge prism. The drive source rotationally drives the at least one wedge prism, and thereby the at least one wedge prism deflects emission light from the laser light source in a conical shape. Then, the at least one lens and the at least one wedge prism are integrated.

### INCORPORATION BY REFERENCE

This application is based upon and claims the benefit of priority from Japanese patent application No. 2022-206482, filed on Dec. 23, 2022, the disclosure of which is incorporated herein in its entirety by reference.

### TECHNICAL FIELD

The present disclosure relates to a LiDAR apparatus.

### BACKGROUND ART

Non Patent Literature 1 (Toshinori Aoyagi, Toshiharu Izumi, Tetsu Sakai, and Tomohiro Nagai, “Estimation of roughness length and zero plane displacement height of urban surfaces using the DBS observation dataset obtained by a Doppler LiDAR system”, Proceedings of the 23rd National Symposium on Wind Engineering, https://www.jstage.jst.go.jp/article/kazekosymp/23/0/23_43/_pdf) discloses an active wind measurement system using an optical measurement Doppler LiDAR. The system provides a conical scanning mechanism using a wedge prism, and a vertical distribution of wind can be acquired every several seconds by a doppler beam swinging (DBS) measurement method.

In addition, as a literature relating to optical path control of laser light, for example, Patent Literature 1 (Japanese Unexamined Patent Application Publication No. 2020-009843) and Patent Literature 2 (Japanese Unexamined Patent Application Publication No. 2006-148711) have been known.

When the inventor of the present application tried to apply a conical scanning mechanism disclosed in above-described Non Patent Literature 1 to a LiDAR apparatus, the inventor found a new problem with respect to a rotation speed of a wedge prism. In other words, the rotation speed of the wedge prism tends to fluctuate due to disturbance such as vibration applied from an outside. When the rotation speed of the wedge prism fluctuates, point cloud density of point cloud data to be output from the LiDAR apparatus is not stable. Specifically, when the rotation speed of the wedge prism temporarily increases, the point cloud density of the point cloud data becomes locally coarse, and when the rotation speed of the wedge prism temporarily decreases, the point cloud density of the point cloud data becomes locally dense.

The above-described problem particularly becomes apparent when attempting to apply the above-described LiDAR apparatus to foreign object detection. This is because stabilization of the point cloud density is indispensable for detecting a foreign object of an order of several centimeters at a point several kilometers away.

### SUMMARY

An example object of the present disclosure is to provide a technique for achieving stable rotation of a wedge prism.

In an example aspect of the present disclosure, a LiDAR apparatus includes:
a laser light source; and
at least one lens and a conical scanning mechanism configured to control an optical path of emission light from the laser light source, wherein
the conical scanning mechanism includes at least one wedge prism and a drive source that rotationally drives the at least one wedge prism, and the at least one wedge prism deflects emission light from the laser light source in a conical shape by rotationally driving the at least one wedge prism by the drive source, and
the at least one lens and the at least one wedge prism are integrated.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a schematic diagram of a LiDAR apparatus;

FIG. 2 is a functional block diagram of the LiDAR apparatus;

FIG. 3 is an optical path diagram of an optical path control unit;

FIG. 4 is a diagram illustrating a configuration example of an optical system constituting the optical path control unit;

FIG. 5 is a diagram illustrating a configuration example of an optical system constituting the optical path control unit;

FIG. 6 is a diagram illustrating a configuration example of an optical system constituting the optical path control unit;

FIG. 7 is an optical path diagram of the optical path control unit;

FIG. 8 is a diagram illustrating a configuration example of an optical system constituting the optical path control unit;

FIG. 9 is an optical path diagram of the optical path control unit;

FIG. 10 is a diagram illustrating a configuration example of an optical system constituting the optical path control unit;

FIG. 11 is a diagram illustrating a configuration example of an optical system constituting the optical path control unit;

FIG. 12 is a diagram illustrating a configuration example of an optical system constituting the optical path control unit;

FIG. 13 is an optical path diagram of the optical path control unit; and

FIG. 14 is an optical path diagram of the optical path control unit.

### EXAMPLE EMBODIMENT

### (Outline of the Present Disclosure)

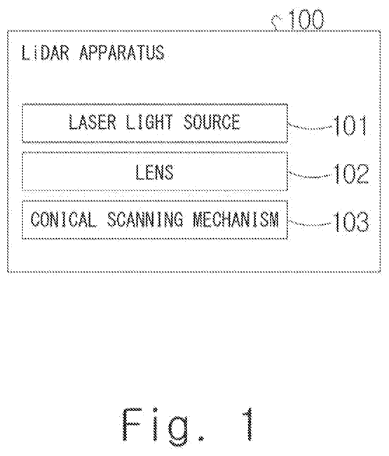

Hereinafter, an outline of the present disclosure will be described with reference to FIG. 1.

As illustrated in FIG. 1, a LiDAR apparatus 100 includes a laser light source 101, at least one lens 102 that controls an optical path of emission light from the laser light source 101, and a conical scanning mechanism 103 that controls an optical path of emission light from the laser light source 101.

The conical scanning mechanism 103 includes at least one wedge prism, and a drive source that rotationally drives the at least one wedge prism. The at least one wedge prism deflects emission light from the laser light source 101 in a conical shape by rotationally driving the at least one wedge prism by the drive source.

Then, the at least one lens 102 and the at least one wedge prism are integrated.

According to the above configuration, stable rotation of the wedge prism can be achieved. In addition, it is possible to contribute to a decrease in size of the LiDAR apparatus 100 and suppression of a power loss of emission light.

### First Example Embodiment

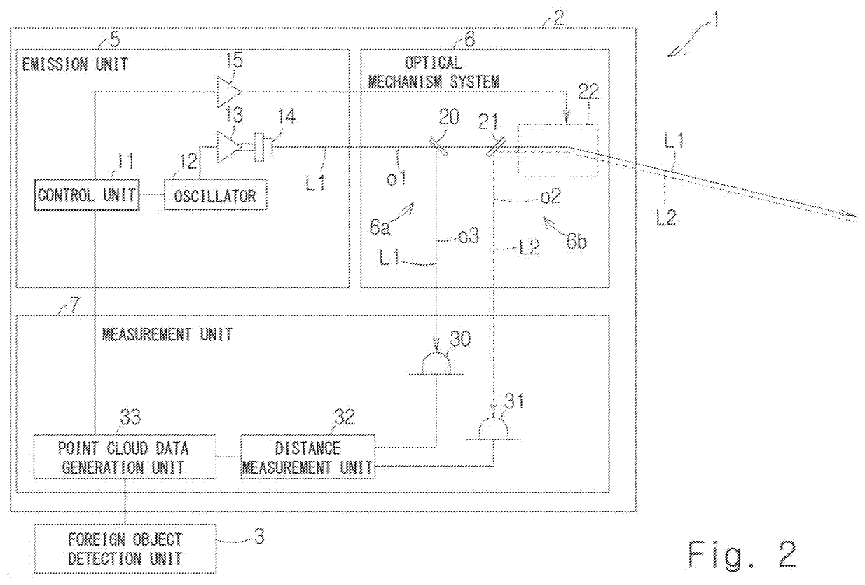

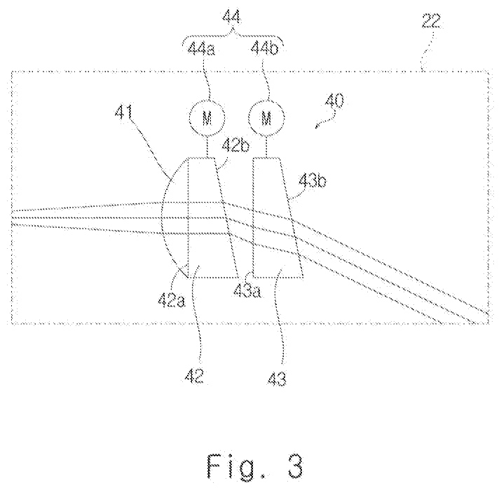

Next, a first example embodiment will be described with reference to FIGS. 2 and 3. FIG. 2 illustrates a foreign object detection system 1. The foreign object detection system 1 of the present example embodiment is used, for example, in order to detect a minute foreign object of an order of several centimeters left on a paved road surface such as a runway, a taxiway, or an apron of an airport from a place several kilometers away. Therefore, the foreign object detection system 1 includes a three-dimensional LiDAR scanner 2 and a foreign object detection apparatus 3. The three-dimensional LiDAR scanner 2 generates point cloud data to be monitored. The foreign object detection apparatus 3 detects a minute foreign object left on a paved road surface, based on the point cloud data generated by the three-dimensional LiDAR scanner 2.

The three-dimensional LiDAR scanner 2 is one specific example of a LiDAR apparatus. The three-dimensional LiDAR scanner 2 adopts a time of flight (ToF) method as a distance measurement method. However, instead of this, the three-dimensional LiDAR scanner 2 may adopt a frequency modulated continuous wave (FMCW) method or an amplitude-modulated continuous wave (AMCW) method as the distance measurement method.

The three-dimensional LiDAR scanner 2 includes an emission unit 5, an optical mechanism system 6, and a measurement unit 7.

The emission unit 5 includes a control unit 11, an oscillator 12, a light source driver 13, a laser light source 14, and a scan driver 15.

The optical mechanism system 6 includes an irradiation optical system 6a and a light reception optical system 6b. The irradiation optical system 6a includes a first optical element 20, and an optical path control unit 22. The light reception optical system 6b includes a second optical element 21, and an optical path control unit 22. In other words, the irradiation optical system 6a and the light reception optical system 6b share the optical path control unit 22.

The measurement unit 7 includes a light reception element 30, a light reception element 31 (a light reception means), a distance measurement unit 32 (a distance measurement means), and a point cloud data generation unit 33 (a point cloud data generation means).

The control unit 11 controls the oscillator 12. The light source driver 13 drives the laser light source 14, based on a pulse signal generated by the oscillator 12. The laser light source 14 is, for example, a fiber laser using an optical fiber. The laser light source 14 intermittently emits laser light L1 by being driven by the light source driver 13. The laser light L1 emitted from the laser light source 14 is also referred to as emission light.

On an optical axis O1 of the irradiation optical system 6a, the laser light source 14, the first optical element 20, the second optical element 21, and the optical path control unit 22 are disposed in series in this order.

The first optical element 20 is typically a beam splitter. The laser light L1 passes through the first optical element 20 and also is reflected by the first optical element 20, travels along an optical axis O3, and is incident on the light reception element 30. A non-illustrated condenser lens is provided on the optical axis O3, and the laser light L1 is condensed on the light reception element 30 by the condenser lens.

The second optical element 21 is typically a half mirror. The laser light L1 passes through the second optical element 21, and is incident on the optical path control unit 22.

The optical path control unit 22 controls an optical path of the laser light L1 emitted from the laser light source 14. In other words, the optical path control unit 22 deflects the laser light L1 intermittently emitted from the laser light source 14 in a conical shape. That is, the optical path control unit 22 achieves a conical scanning method. A configuration of the optical path control unit 22 will be described later.

The control unit 11 outputs a drive signal to the scan driver 15 in such a way that the optical path control unit 22 executes desired optical path control. The scan driver 15 controls the optical path control unit 22, based on the drive signal input from the control unit 11. In other words, the control unit 11 controls an irradiation direction of the laser light L1 by driving the scan driver 15.

On an optical axis O2 of the light reception optical system 6b, the optical path control unit 22, the second optical element 21, and the light reception element 31 are disposed in an order in which a reflected light L2 is incident. A non-illustrated condenser lens is provided on the optical axis O2, and the reflected light L2 is condensed on the light reception element 31 by the condenser lens. The light reception element 31 receives the reflected light L2 from a distance measurement target.

Note that, in FIG. 2, the optical path of the laser light L1 and an optical path of the reflected light L2 are separated for clarity. In practice, however, they may overlap with each other.

The measurement unit 7 measures a distance from the three-dimensional LiDAR scanner 2 to a monitoring target, based on a time-series luminance signal acquired by analog-to-digital conversion of an electric signal acquired by converting the reflected light L2 into a signal. Specifically, it is as follows.

The distance measurement unit 32 converts an electric signal output from the light reception element 31 into a time-series luminance signal at a predetermined sampling interval. The time-series luminance signal is a series of luminance values acquired by sampling a temporal change in luminance of the reflected light L2 at a predetermined sampling interval.

The distance measurement unit 32 calculates a distance to a distance measurement point, based on a time required for the light reception element 31 to receive the reflected light L2 after the laser light L1 is emitted from the laser light source 14. In other words, the distance measurement unit 32 measures the distance from the three-dimensional LiDAR scanner 2 to the monitoring target, based on a time difference between timing at which the light reception element 30 detects the laser light L1 and timing at which the light reception element 31 detects the reflected light L2, based on the time-series luminance signal, and generates distance data (the ToF method).

However, as described above, a method of generating the distance data (that is, the distance measurement method) by the distance measurement unit 32 is not limited to the ToF method. For example, instead of the ToF method, the FMCW method may be used.

The point cloud data generation unit 33 generates point cloud data, based on a calculation result by the distance measurement unit 32. In other words, the point cloud data generation unit 33 generates point data for each distance measurement point, based on emission direction information of the laser light L1 output from the control unit 11 and distance data output from the distance measurement unit 32. Then, the point cloud data generation unit 33 generates point cloud data that are a set of pieces of point data, and outputs the generated point cloud data to the foreign object detection apparatus 3.

The foreign object detection apparatus 3 detects a minute foreign object left on a paved road surface, based on the point cloud data acquired from the three-dimensional LiDAR scanner 2. Then, the foreign object detection apparatus 3 notifies an operator of a detection result.

Note that, as described above, the optical path control unit 22 may be shared by the irradiation optical system 6a and the light reception optical system 6b. In this case, for example, as illustrated in FIG. 2, the second optical element 21 is disposed between the first optical element 20 and the optical path control unit 22. As a result, both the laser light L1 and the reflected light L2 pass through the optical path control unit 22. However, as will be described later with reference to FIG. 3, the optical path control unit 22 is a member for mainly controlling the optical path of the laser light L1 from a viewpoint of achieving conical scanning. Therefore, only the laser light L1 between the laser light L1 and the reflected light L2 may pass through the optical path control unit 22. This is achieved, for example, by disposing the optical path control unit 22 between the first optical element 20 and the second optical element 21. Note that, an optical path illustrated in the drawings after FIG. 3 illustrates, in principle, the optical path of the laser light L1.

Next, the optical path control unit 22 will be described in detail with reference to FIG. 3.

As illustrated in FIG. 3, the optical path control unit 22 includes a conical scanning mechanism 40, and a collimator lens 41.

The conical scanning mechanism 40 includes a first wedge prism 42, a second wedge prism 43, and a drive source 44. The first wedge prism 42 and the second wedge prism 43 are disposed in this order in a direction away from the laser light source 14. The drive source 44 includes a motor 44a and a motor 44b. The motor 44a and the motor 44b are driven by the scan driver 15 illustrated in FIG. 2. The motor 44a and the motor 44b individually rotationally drive the first wedge prism 42 and the second wedge prism 43. In other words, the drive source 44 individually rotationally drives the first wedge prism 42 and the second wedge prism 43. A rotation speed of the first wedge prism 42 and a rotation speed of the second wedge prism 43 are different from each other. Typically, the rotation speed of the first wedge prism 42 is lower than the rotation speed of the second wedge prism 43. The control unit 11 in FIG. 2 performs feedback control on the motor 44a in such a way that the rotation speed of the first wedge prism 42 becomes constant. Similarly, the control unit 11 performs feedback control on the motor 44b in such a way that the rotation speed of the second wedge prism 43 becomes constant. The first wedge prism 42 deflects the laser light L1 in a conical shape. Similarly, the second wedge prism 43 deflects the laser light L1 in a conical shape. With the above configuration, the conical scanning mechanism 40 achieves conical scanning in which a distribution of distance measurement points viewed from the three-dimensional LiDAR scanner 2 is disk-shaped. Various known techniques can be used for such conical scanning. For example, a technique similar to that described in Reference Literature 1 below can be used.

[Reference Literature 1] Thorlabs, Inc., Application Note “Risley Prism Scanner”, https://www.thorlabs.co.jp/images/tabimages/Risley_Prism_Scanner_App_Note.pdf

The first wedge prism 42 has an incidence surface 42a on which the laser light L1 is incident, and an emission surface 42b from which the laser light L1 is emitted. The incidence surface 42a is inclined with respect to the emission surface 42b. Similarly, the second wedge prism 43 has an incidence surface 43a on which the laser light L1 is incident, and an emission surface 43b from which the laser light L1 is emitted. The incidence surface 43a is inclined with respect to the emission surface 43b.

The collimator lens 41 controls the optical path of the laser light L1 emitted from the laser light source 14. Specifically, the collimator lens 41 is configured to convert the laser light L1 emitted from the laser light source 14 into parallel light, and is formed into a planoconvex spherical lens shape. For example, when a fiber laser is used as the laser light source 14, there is a possibility that the laser light L1 incident on the optical path control unit 22 is not sufficiently collimated. The collimator lens 41 is provided in order to collimate the laser light L1.

Herein, the collimator lens 41 is integrated with the first wedge prism 42. In other words, the collimator lens 41 is provided on the incidence surface 42a of the first wedge prism 42. According to this, stable rotation of the first wedge prism 42 can be achieved. In addition, it is possible to contribute to a decrease in size of the three-dimensional LiDAR scanner 2 and suppression of a power loss of emission light.

In other words, since the collimator lens 41 and the first wedge prism 42 are integrated, a space between the collimator lens 41 and the first wedge prism 42 is not required, as compared with a case where the collimator lens 41 and the first wedge prism 42 are disposed apart from each other, and thereby it contributes to the decrease in size of the three-dimensional LiDAR scanner 2.

In addition, since the collimator lens 41 and the first wedge prism 42 are integrated, the number of interfaces in passing through the collimator lens 41 and the first wedge prism 42 by the laser light L1 is reduced, as compared with the case where the collimator lens 41 and the first wedge prism 42 is disposed apart from each other. Therefore, the power loss of the laser light L1 is suppressed, and a distance that the three-dimensional LiDAR scanner 2 can measure is extended.

Further, since the collimator lens 41 and the first wedge prism 42 are integrated, inertia of the first wedge prism 42 is increased, as compared with the case where the collimator lens 41 and the first wedge prism 42 are disposed apart from each other. Therefore, for example, a rotation speed of the first wedge prism 42 is unlikely to fluctuate due to disturbance such as vibration applied from an outside, and point cloud density of point cloud data output from the three-dimensional LiDAR scanner 2 is made uniform over a wide range. As a result, a foreign object of an order of several centimeters can be detected with high accuracy at a point several kilometers away.

In the present description, “two optical elements are integrated” includes “two optical elements are integrally formed from one optical material” and “two optical elements having the same refractive index are bonded to each other”. In the latter case, the two optical elements have the same refractive index, for example, by being made of the same material.

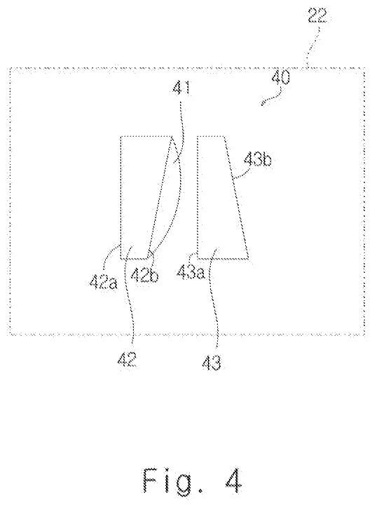

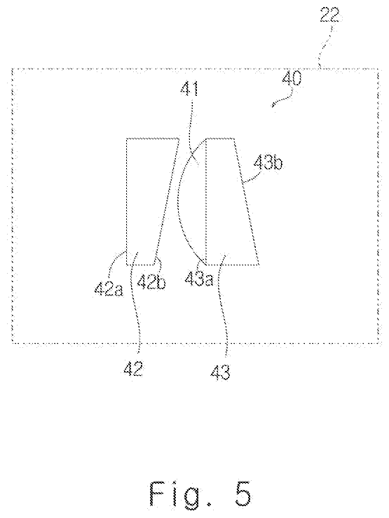

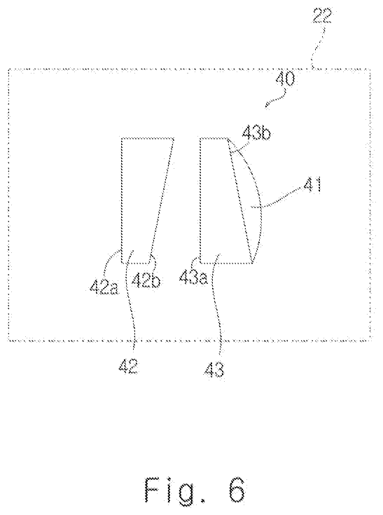

Hereinafter, a modification example of the first example embodiment will be described with reference to FIGS. 4 to 6. For example, as illustrated in FIG. 3, in the above-described first example embodiment, the collimator lens 41 is provided on the incidence surface 42a of the first wedge prism 42. However, instead of this, as illustrated in FIG. 4, the collimator lens 41 may be provided on the emission surface 42b of the first wedge prism 42. As illustrated in FIG. 5, the collimator lens 41 may be provided on the incidence surface 43a of the second wedge prism 43. As illustrated in FIG. 6, the collimator lens 41 may be provided on the emission surface 43b of the second wedge prism 43. In any case, it is possible to achieve stable rotation of the first wedge prism 42 together with the decrease in size of the three-dimensional LiDAR scanner 2 and suppression of the power loss of emission light.

### Second Example Embodiment

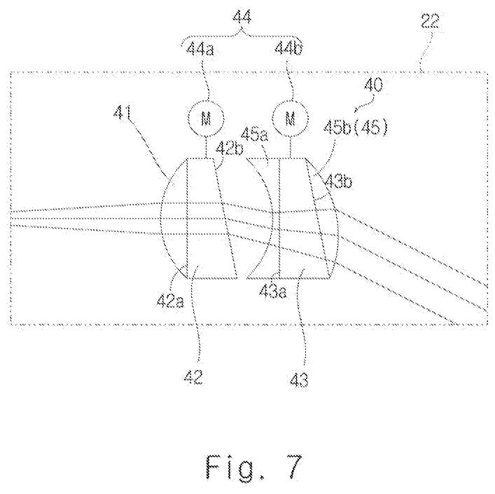

Next, a second example embodiment of the present disclosure will be described with reference to FIG. 7. Hereinafter, the present example embodiment will be mainly described in terms of a difference from the above-described first example embodiment, and redundant description will be omitted.

For example, as illustrated in FIG. 3, in the above-described first example embodiment, the optical path control unit 22 includes the conical scanning mechanism 40, and the collimator lens 41.

In contrast, in the present example embodiment, as illustrated in FIG. 7, an optical path control unit 22 includes a conical scanning mechanism 40, a collimator lens 41, and two lenses 45 for a beam expander. The two lenses 45 include a planoconcave lens 45a and a planoconvex lens 45b. The planoconcave lens 45a and the planoconvex lens 45b are disposed in the described order in a direction away from a laser light source 14. The two lenses 45 for the beam expander control an optical path of a laser light L1 emitted from the laser light source 14. Specifically, the two lenses 45 for the beam expander expand a beam diameter of the laser light L1 emitted from the laser light source 14.

Then, the collimator lens 41 is provided on an incidence surface 42a of a first wedge prism 42, and is integrated with the first wedge prism 42. The planoconcave lens 45a is provided on an incidence surface 43a of a second wedge prism 43, and is integrated with the second wedge prism 43. The planoconvex lens 45b is provided on an emission surface 43b of the second wedge prism 43, and is integrated with the second wedge prism 43. According to this, stable rotation of the wedge prism can be achieved. In addition, it is possible to contribute to a decrease in size of a three-dimensional LiDAR scanner 2 and suppression of a power loss of emission light.

In other words, since the collimator lens 41 and the first wedge prism 42 are integrated, a space between the collimator lens 41 and the first wedge prism 42 is not required, as compared with a case where the collimator lens 41 and the first wedge prism 42 are disposed apart from each other, and thereby it contributes to the decrease in size of the three-dimensional LiDAR scanner 2.

In addition, since the collimator lens 41 and the first wedge prism 42 are integrated, the number of interfaces in passing through the collimator lens 41 and the first wedge prism 42 by the laser light L1 is reduced, as compared with the case where the collimator lens 41 and the first wedge prism 42 is disposed apart from each other. Therefore, the power loss of the laser light L1 is suppressed, and a distance that the three-dimensional LiDAR scanner 2 can measure is extended.

Further, since the collimator lens 41 and the first wedge prism 42 are integrated, inertia of the first wedge prism 42 is increased, as compared with the case where the collimator lens 41 and the first wedge prism 42 are disposed apart from each other. Therefore, for example, a rotation speed of the first wedge prism 42 is unlikely to fluctuate due to disturbance such as vibration applied from an outside, and point cloud density of point cloud data output from the three-dimensional LiDAR scanner 2 is made uniform over a wide range. As a result, a foreign object of an order of several centimeters can be detected with high accuracy at a point several kilometers away.

Further, since the two lenses 45 and the second wedge prism 43 are integrated, a space between the two lenses 45 and the second wedge prism 43 is not required, as compared with a case where the two lenses 45 and the second wedge prism 43 are disposed apart from each other, and thereby it contributes to the decrease in size of the three-dimensional LiDAR scanner 2.

In addition, since the two lenses 45 and the second wedge prism 43 are integrated, the number of interfaces in passing through the two lenses 45 and the second wedge prism 43 by the laser light L1 is reduced, as compared with the case where the two lenses 45 and the second wedge prism 43 are disposed apart from each other. Therefore, the power loss of the laser light L1 is suppressed, and the distance that the three-dimensional LiDAR scanner 2 can measure is extended.

Further, since the two lenses 45 and the second wedge prism 43 are integrated, inertia of the second wedge prism 43 is increased, as compared with the case where the two lenses 45 and the second wedge prism 43 are disposed apart from each other. Therefore, for example, a rotation speed of the second wedge prism 43 is unlikely to fluctuate due to disturbance such as vibration applied from the outside, and point cloud density of point cloud data output from the three-dimensional LiDAR scanner 2 is made uniform over a wide range. As a result, a foreign object of an order of several centimeters can be detected with high accuracy at a point several kilometers away.

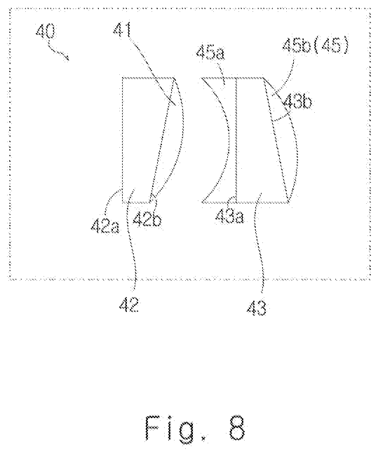

Hereinafter, a modification example of the second example embodiment will be described with reference to FIG. 8. For example, as illustrated in FIG. 7, in the above-described second example embodiment, the collimator lens 41 is provided on the incidence surface 42a of the first wedge prism 42. However, instead of this, as illustrated in FIG. 8, the collimator lens 41 may be provided on an emission surface 42b of the first wedge prism 42. Also in this case, it is possible to achieve stable rotation of the first wedge prism 42 together with the decrease in size of the three-dimensional LiDAR scanner 2 and suppression of the power loss of the emission light.

### Third Example Embodiment

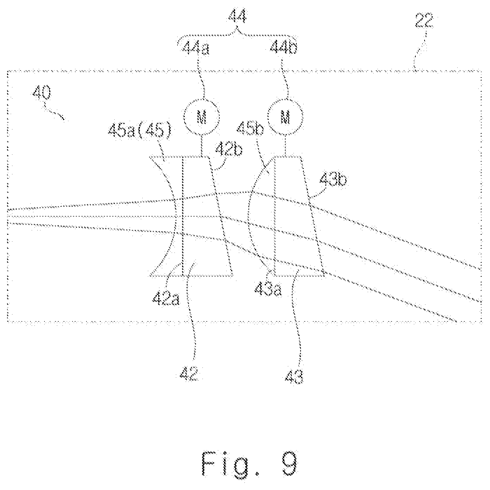

Next, a third example embodiment of the present disclosure will be described with reference to FIG. 9. Hereinafter, the present example embodiment will be mainly described in terms of a difference from the above-described first example embodiment, and redundant description will be omitted.

For example, as illustrated in FIG. 3, in the above-described first example embodiment, the optical path control unit 22 includes the conical scanning mechanism 40, and the collimator lens 41.

In contrast, in the present example embodiment, as illustrated in FIG. 9, an optical path control unit 22 includes a conical scanning mechanism 40, and two lenses 45 for a beam expander. The two lenses 45 include a planoconcave lens 45a and a planoconvex lens 45b. The planoconcave lens 45a and the planoconvex lens 45b are disposed in the described order in a direction away from a laser light source 14.

Then, the planoconcave lens 45a is provided on an incidence surface 42a of a first wedge prism 42, and is integrated with the first wedge prism 42. The planoconvex lens 45b is provided on an incidence surface 43a of a second wedge prism 43, and is integrated with the second wedge prism 43. According to this, stable rotation of the wedge prism can be achieved. In addition, it is possible to contribute to a decrease in size of a three-dimensional LiDAR scanner 2 and suppression of a power loss of emission light.

In other words, since the planoconcave lens 45a and the first wedge prism 42 are integrated and also the planoconvex lens 45b and the second wedge prism 43 are integrated, it contributes to the decrease in size of the three-dimensional LiDAR scanner 2, as compared with a case of not being integrated.

In addition, since the planoconcave lens 45a and the first wedge prism 42 are integrated and also the planoconvex lens 45b and the second wedge prism 43 are integrated, the number of interfaces in passing through the two lenses 45, the first wedge prism 42, and the second wedge prism 43 by laser light L1 is reduced, as compared with the case of not being integrated. Therefore, the power loss of the laser light L1 is suppressed, and a distance that the three-dimensional LiDAR scanner 2 can measure is extended.

Further, since the planoconcave lens 45a and the first wedge prism 42 are integrated and also the planoconvex lens 45b and the second wedge prism 43 are integrated, inertia of each of the first wedge prism 42 and the second wedge prism 43 is increased, as compared with the case of not being integrated. Therefore, for example, a rotation speed of each of the first wedge prism 42 and the second wedge prism 43 is unlikely to fluctuate due to disturbance such as vibration applied from an outside, and point cloud density of point cloud data output from the three-dimensional LiDAR scanner 2 is made uniform over a wide range. As a result, a foreign object of an order of several centimeters can be detected with high accuracy at a point several kilometers away.

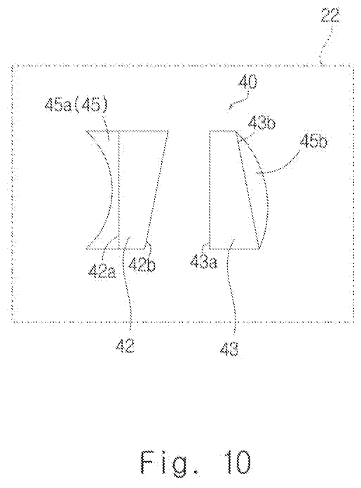

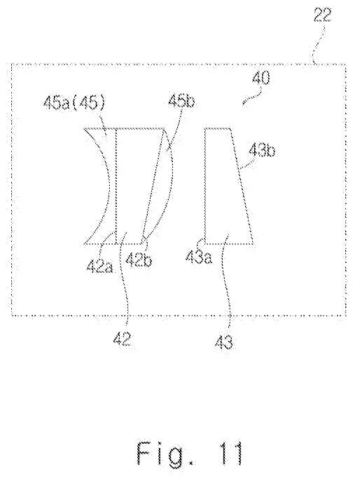

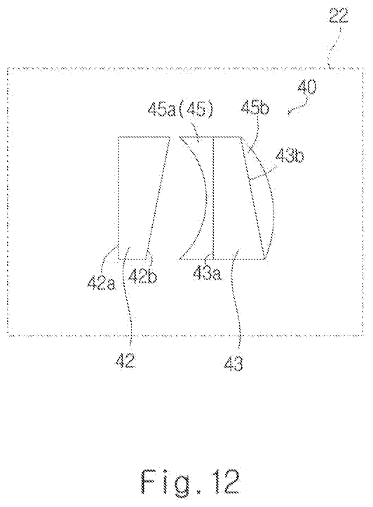

Hereinafter, a modification example of the third example embodiment will be described with reference to FIGS. 10 to 12. For example, as illustrated in FIG. 9, in the above-described third example embodiment, the planoconcave lens 45a is provided on the incidence surface 42a of the first wedge prism 42, and the planoconvex lens 45b is provided on the incidence surface 43a of the second wedge prism 43. However, instead of this, as illustrated in FIG. 10, the planoconcave lens 45a may be provided on the incidence surface 42a of the first wedge prism 42, and the planoconvex lens 45b may be provided on an emission surface 43b of the second wedge prism 43. In addition, as illustrated in FIG. 11, the planoconcave lens 45a may be provided on the incidence surface 42a of the first wedge prism 42, and the planoconvex lens 45b may be provided on an emission surface 42b of the first wedge prism 42. Further, as illustrated in FIG. 12, the planoconcave lens 45a may be provided on the incidence surface 43a of the second wedge prism 43, and the planoconvex lens 45b may be provided on the emission surface 43b of the second wedge prism 43. In any case, it is possible to achieve stable rotation of the first wedge prism 42 together with the decrease in size of the three-dimensional LiDAR scanner 2 and suppression of the power loss of emission light.

### Fourth Example Embodiment

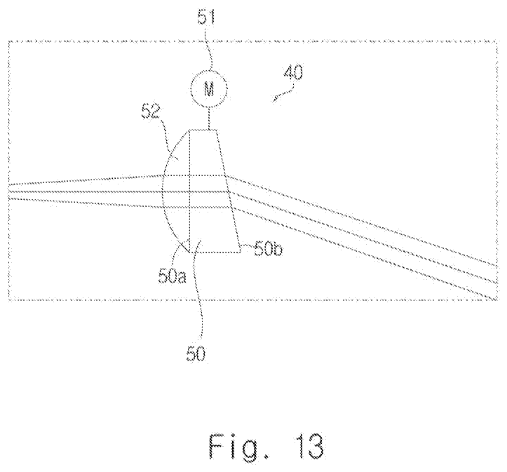

Next, a fourth example embodiment of the present disclosure will be described with reference to FIG. 13. Hereinafter, the present example embodiment will be mainly described in terms of a difference from the above-described first example embodiment, and redundant description will be omitted.

In the first example embodiment, for example, as illustrated in FIG. 3, the conical scanning mechanism 40 includes the first wedge prism 42 and the second wedge prism 43. As a result, the conical scanning mechanism 40 achieves conical scanning in which a distribution of distance measurement points viewed from a three-dimensional LiDAR scanner 2 is disk-shaped.

In contrast, in the present example embodiment, as illustrated in FIG. 13, a conical scanning mechanism 40 includes one wedge prism 50, and a motor 51 (drive source) that rotationally drives the wedge prism 50. Then, the motor 51 rotationally drives the wedge prism 50, and thereby laser light L1 is deflected in a conical shape. As a result, the conical scanning mechanism 40 achieves conical scanning in which a distribution of distance measurement points viewed from a three-dimensional LiDAR scanner 2 is arc-shaped. The wedge prism 50 has an incidence surface 50a on which the laser light L1 is incident, and an emission surface 50b from which the laser light L1 is emitted. The incidence surface 50a is inclined with respect to the emission surface 50b.

Then, an optical path control unit 22 includes the conical scanning mechanism 40, and a collimator lens 52. The collimator lens 52 is configured to convert the laser light L1 emitted from a laser light source 14 into parallel light, and is formed into a planoconvex spherical lens shape. Then, the collimator lens 52 is integrated with the wedge prism 50. In other words, the collimator lens 52 is provided on the incidence surface 50a of the wedge prism 50. According to this, stable rotation of the wedge prism 50 can be achieved. In addition, it is possible to contribute to a decrease in size of the three-dimensional LiDAR scanner 2 and suppression of a power loss of emission light.

In other words, since the collimator lens 52 and the wedge prism 50 are integrated, a space between the collimator lens 52 and the wedge prism 50 is not required, as compared with a case where the collimator lens 52 and the wedge prism 50 are disposed apart from each other, and thereby it contributes to the decrease in size of the three-dimensional LiDAR scanner 2.

In addition, since the collimator lens 52 and the wedge prism 50 are integrated, the number of interfaces in passing through the collimator lens 52 and the wedge prism 50 by the laser light L1 is reduced, as compared with the case where the collimator lens 52 and the wedge prism 50 are disposed apart from each other. Therefore, the power loss of the laser light L1 is suppressed, and a distance that the three-dimensional LiDAR scanner 2 can measure is extended.

Further, since the collimator lens 52 and the wedge prism 50 are integrated, inertia of the wedge prism 50 is increased, as compared with the case where the collimator lens 52 and the wedge prism 50 are disposed apart from each other. Therefore, for example, a rotation speed of the wedge prism 50 is unlikely to fluctuate due to disturbance such as vibration applied from an outside.

The above-described collimator lens 52 may be provided on the emission surface 50b of the wedge prism 50, instead of being provided on the incidence surface 50a of the wedge prism 50. Even in this case, it is possible to achieve stable rotation of the wedge prism 50 together with the decrease in size of the three-dimensional LiDAR scanner 2 and the suppression of the power loss of the emission light.

### Fifth Example Embodiment

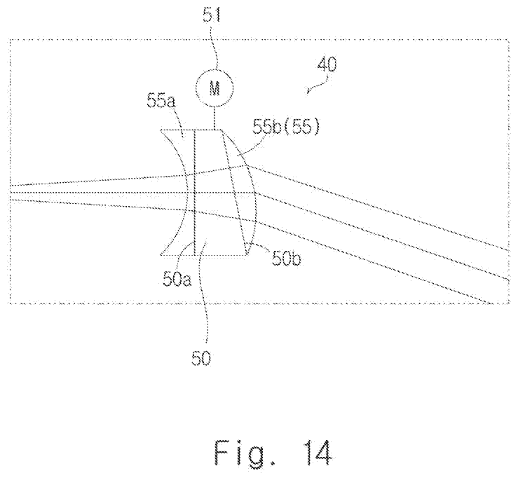

Next, a fifth example embodiment of the present disclosure will be described with reference to FIG. 14. Hereinafter, the present example embodiment will be mainly described in terms of a difference from the above-described fourth example embodiment, and redundant description will be omitted.

In the fourth example embodiment, for example, as illustrated in FIG. 13, the optical path control unit 22 includes the conical scanning mechanism 40 and the collimator lens 52. The collimator lens 52 is provided on the incidence surface 50a of the wedge prism 50 constituting the conical scanning mechanism 40.

In contrast, in the present example embodiment, as illustrated in FIG. 14, an optical path control unit 22 includes a conical scanning mechanism 40, and two lenses 55 for a beam expander. The two lenses 55 include a planoconcave lens 55a and a planoconvex lens 55b. The planoconcave lens 55a is provided on an incidence surface 50a of a wedge prism 50, and is integrated with the wedge prism 50. The planoconvex lens 55b is provided on an emission surface 50b of the wedge prism 50, and is integrated with the wedge prism 50. According to this, stable rotation of the wedge prism 50 can be achieved. In addition, it is possible to contribute to a decrease in size of the three-dimensional LiDAR scanner 2 and suppression of a power loss of emission light.

In other words, since the two lenses 55 and the wedge prism 50 are integrated, a space between the two lenses 55 and the wedge prism 50 is not required, as compared with a case where the two lenses 55 and the wedge prism 50 are disposed apart from each other, and thereby it contributes to the decrease in size of the three-dimensional LiDAR scanner 2.

In addition, since the two lenses 55 and the wedge prism 50 are integrated, the number of interfaces in passing through the two lenses 55 and the wedge prism 50 by laser light L1 is reduced, as compared with the case where the two lenses 55 and the wedge prism 50 are disposed apart from each other. Therefore, the power loss of the laser light L1 is suppressed, and a distance that the three-dimensional LiDAR scanner 2 can measure is extended.

Further, since the two lenses 55 and the wedge prism 50 are integrated, inertia of the wedge prism 50 is increased, as compared with the case where the two lenses 55 and the wedge prism 50 are disposed apart from each other. Therefore, for example, a rotation speed of the wedge prism 50 is unlikely to fluctuate due to disturbance such as vibration applied from an outside.

According to the present disclosure, stable rotation of a wedge prism can be achieved.

The first and second example embodiments can be combined as desirable by one of ordinary skill in the art.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

What is claimed is:

1. A LIDAR apparatus comprising:
a laser light source; and
at least one lens and a conical scanning mechanism configured to control an optical path of emission light from the laser light source, wherein
the conical scanning mechanism includes at least one wedge prism and a drive source that rotationally drives the at least one wedge prism, and the at least one wedge prism deflects emission light from the laser light source in a conical shape by rotationally driving the at least one wedge prism by the drive source, and
the at least one lens and the at least one wedge prism are integrated.

2. The LiDAR apparatus according to claim 1, wherein the at least one lens is disposed on an incidence surface of the at least one wedge prism on which emission light from the laser light source is incident, or an emission surface of the at least one wedge prism on which emission light from the laser light source is emitted.

3. The LiDAR apparatus according to claim 2, wherein the at least one lens includes at least any one of a collimator lens, and two lenses constituting a beam expander.

4. The LiDAR apparatus according to claim 1, wherein
the at least one wedge prism includes a first wedge prism and a second wedge prism,
the first wedge prism and the second wedge prism are disposed in the described order from the laser light source, and
the drive source individually rotationally drives the first wedge prism and the second wedge prism.

5. The LiDAR apparatus according to claim 4, wherein the at least one lens is disposed on an incidence surface of the first wedge prism on which emission light from the laser light source is incident, on an emission surface of the first wedge prism from which emission light from the laser light source is emitted, on an incidence surface of the second wedge prism on which emission light from the laser light source is incident, or on an emission surface of the second wedge prism from which emission light from the laser light source is emitted.

6. The LiDAR apparatus according to claim 5, wherein the at least one lens includes at least any one of a collimator lens, and two lenses constituting a beam expander.

7. The LiDAR apparatus according to claim 6, wherein
the at least one lens includes the collimator lens, and the two lenses constituting the beam expander,
the collimator lens is disposed on the incidence surface or the emission surface of the first wedge prism, and
each of the two lenses is disposed on the incidence surface and the emission surface of the second wedge prism.

8. The LiDAR apparatus according to claim 6, wherein
the at least one lens includes the two lenses constituting the beam expander, and
each of the two lenses is disposed on any two surfaces of the incidence surface and the emission surface of the first wedge prism, and the incidence surface and the emission surface of the second wedge prism.

9. The LiDAR apparatus according to claim 1, further comprising a control unit configured to control the drive source in such a way that a rotation speed of the at least one wedge prism is constant.

10. The LiDAR apparatus according to claim 9, further comprising:
light reception means for receiving reflected light from a distance measurement target;
distance measurement means for calculating a distance to a distance measurement point, based on the emission light and the reflected light; and
point cloud data generation means for generating point cloud data, based on a calculation result by the distance measurement means.
